(19) United States
(12) Patent Application Publication
(10) Pub. No.: US 2006/0280049 A1
(43) Pub. Date: Dec. 14, 2006

(54) OPTICAL DISC LABEL PRINTING USING OPTICAL PICKUP UNIT WITH MULTIPLE FOCI

(76) Inventors: Bow-Yi Jang, Taoyuan (TW); Hsiao Lin, Taoyuan (TW); William Wang, Taoyuan (TW); Fung-Hsu Wu, Taoyuan (TW); Peng Chen, Taoyuan (TW); Ta Yuan Lee, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/420,839

(22) Filed: May 30, 2006

(30) Foreign Application Priority Data
May 30, 2005 (TW) 094117666

(51) Int. Cl. G11B 17/22

(52) U.S. Cl. 369/30.3

(57) ABSTRACT

The present invention provides a system for recording an image onto a label layer of an optical disc. The optical disc also includes a data layer on which a plurality of predetermined address codes is marked. The system essentially includes a multi-focal lens module for dividing a laser beam emitted by an optical pick-up unit into a first beam portion and a second beam portion. The first beam portion is focused on the data layer to locate a first position by retrieving the predetermined address codes. The second beam portion is focused on the label layer to record the image at a second position opposite to the first position.

### BACKGROUND OF THE INVENTION

1. Field of the Invention

The present invention relates generally to optical disc label printing and, more particularly, to a system and the method thereof for recording an image onto a label layer of an optical disc.

2. Description of the Prior Art

As the recordable optical discs, such as a CD-R (compact disk recordable) and a CD-RW (compact disk rewritable), have been extensively used for recording a large amount of information, the accompanying issue is the management of optical discs that have already recorded data. Methods for labeling the non-data side of such optical discs with text and figures, for example, have continued to develop as consumers desire more convenient ways to identify the data they've burned onto their own CDs. Generally, methods for labeling an optical disc include physically writing on the non-data side with a permanent marker (e.g. a sharpie marker) or printing out a paper sticker label and sticking it onto the non-data side of the disc. Other physical marking methods developed for implementation in conventional CD drives include ink-jet printing, thermal wax transfer, and thermal dye transfer methods.

The main difficulty for automatically labeling an optical disc is that no tracks or reference marks are provided on the label side (non-data side) for automatically determining a radial position, making optical disc labeling a non-trivial task. In contrast, the data reading/writing strategy in the art of recordable optical discs is usually to form a pregroove on the data layer of the optical discs. Predetermined address codes, such as absolute time in pregroove codes (ATIP codes), are marked on the pregroove; the ATIP codes provide a tracking basis to aid an optical information recording/reproducing apparatus (such as CD-RW drive) to perform data reading/writing. Typically, the predetermined address codes are represented in terms of time. To summarize, when an optical drive is instructed to perform data reading and writing, the ATIP codes are retrieved to seek a particular section, thus simplifying the task of addressing on the data layer of an optical disc.

In recent years, there has been a proposed technology, as disclosed in U.S. Pat. No. 6,864,907, in which a label layer that changes its color in response to heat or light is integrally provided with an optical disc; the label layer is provided on a label face opposite to the recording face to draw images in order to indicate the contents recorded on the optical disc. The label face is set to face an optical pickup, and a laser beam is radiated by the optical pickup to cause the label layer to change its color, so as to form a visible image. A group of alignment marks are pre-printed on the label layer in order to position the images to be printed. Before printing images onto the label layer, the optical disc has to be flipped in order to have the label layer face the optical pickup.

Referring to FIG. 1, U.S. Pat. No. 5,565,668 discloses a scanning system which includes a multi-focal lens 12 having a single lens element; the single lens element is composed of an inner lens portion 12b with a first focal length and an outer annular lens portion 12a with a second focal length. The scanning system, therefore, can establish two separate focal positions from a single light source 10 (i.e. A1 and A2 shown in FIG. 1). Alternately, multiple lens elements may be separately arranged. FIG. 2 illustrates yet another alternative multi-focal lens system comprising a multi-focal lens 14 which includes two separate lens elements: a rear lens element 14a and a front lens element 14b. Light from the source 10 is thereby focused at two separate focal points B1 and B2. Light passing through the rear lens element 14a but not passing through the front lens element 14b is illustrated to focus at the far focal point B2, and light passing through both the rear lens element 14a and the front lens element 14b is illustrated to focus at the near focal point B1. Depending upon the optical properties of the front lens element 14b, the location of focal point B1 may alternately be located at a greater distance from the lens 14.

Accordingly, one objective of the present invention is to provide a system and the method for recording data, such as images, onto a label layer of an optical disc. In addition, the system and method, according to the invention, are able to locate a specific position where the image is to be recorded on the label layer by taking advantage of the predetermined address codes on the data layer. Particularly, a multi-focal lens module is utilized to focus a laser beam on the data layer and the label layer of the optical disc respectively, thereby accomplishing the addressing and printing of the image on the optical disc in one step.

### SUMMARY OF THE INVENTION

According to a second preferred embodiment of the present invention, a system is provided for recording an image onto a label layer of an optical disc. The optical disc also includes a data layer, on which a plurality of predetermined address codes is marked. The recording system, according to the invention, includes a processor, an optical pick-up unit, a multi-focal lens module, and a controller.

The processor is used for receiving data related to a first position which is defined on the data layer, and the optical pick-up unit is used for emitting a laser beam. The multi-focal lens module is capable of dividing the laser beam emitted by the optical pick-up unit into a first beam portion and a second beam portion. The controller, which is operated by the processor, is used for controlling the optical pick-up unit to focus the first beam portion on the data layer to retrieve the predetermined address codes, such that the optical pick-up unit is positioned at the first position, and the optical pick-up unit is also being controlled to focus the second beam portion at a second position on the label layer opposite to the first position, so as to record the image on the label layer.

According to a third preferred embodiment of the invention, a method is provided for recording an image onto a label layer of an optical disc. The optical disc also includes a data layer, on which a plurality of predetermined address codes is marked. The recording method, according to the invention, first receives data related to a first position, which is defined on the data layer. Next, an optical pick-up unit is controlled to emit a laser beam, and the laser beam is divided into a first beam portion and a second beam portion. Afterwards, the optical pick-up unit is controlled to focus the first beam portion on the data layer to retrieve the predetermined address codes, such that the optical pick-up unit is positioned at the first position. Finally, the optical pick-up unit is controlled to focus the second beam portion at a second position on the label layer opposite to the first position, so as to record the image on the label layer.

The advantage and spirit of the invention may be understood by the following recitations together with the appended drawings.

### BRIEF DESCRIPTION OF THE APPENDED DRAWINGS

FIG. 1 illustrates a multi-focal lens in the art, which is capable of establishing two separate focal positions from a single light source.

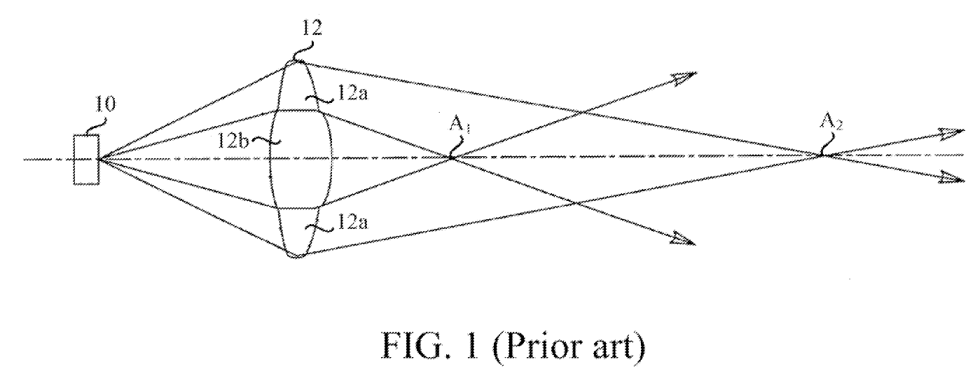

FIG. 2 illustrates an alternate multi-focal lens in the art, which includes two separate lens elements.

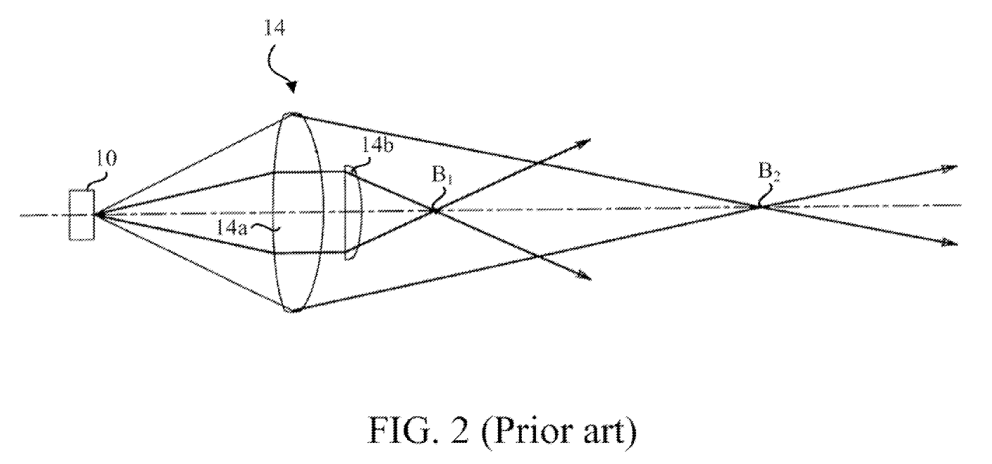

FIG. 3 is a sectional view showing a construction of an optical disc according to a first preferred embodiment of the invention.

FIG. 4 is a schematic diagram showing the configuration and function blocks of a recording system according to a second preferred embodiment of the invention.

FIG. 5 depicts an exemplary embodiment showing the focusing control of a multi-focal lens module according to the invention.

FIG. 6 illustrates a multi-focal lens module, which includes a first lens element and a second lens element, according to one embodiment of the invention.

FIG. 7 is a flowchart showing a method for recording an image onto a label layer of an optical disc according to a third preferred embodiment of the invention.

### DETAILED DESCRIPTION OF THE INVENTION

The recording system, according to the invention, can function like an optical information recording/reproducing apparatus, such as an optical disc drive. More particularly, the recording system may also be used for recording an image onto a label layer of an optical disc.

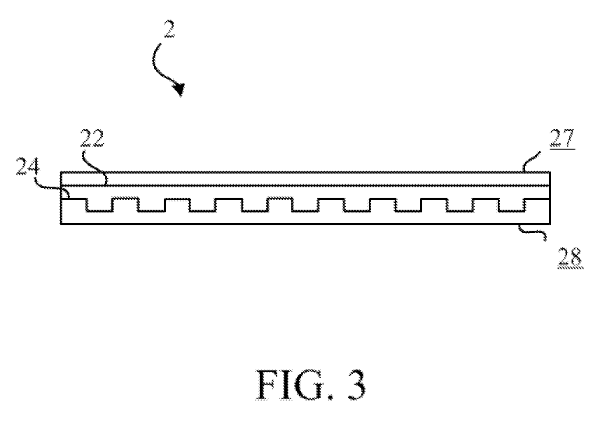

Referring to FIG. 3, FIG. 3 is a sectional view showing a construction of an optical disc 2 according to a first preferred embodiment of the invention. As shown in FIG. 3, the optical disc 2 has a top surface 27 and a bottom surface 28 opposite to the top surface 27. The optical disc 2 also includes a label layer 22, which is configured to form an image in response to heat or light of a laser beam. The image may be exhibited in the form of dots or lines. More particularly, the label layer 22 changes it color to form the image in response to thermal or light energy higher than a threshold. In this embodiment, the label layer 22 may be formed on the top surface 27 or near the top surface 27 of the optical disc 2 by depositing special chemical coating during the manufacture of optical discs. It should be noted that FIG. 3 only shows the later case. The optical disc 2 also includes a data layer 24, on which a plurality of predetermined address codes is marked. In practical applications, the predetermined address codes are Absolute Time In Pregroove (ATIP) codes.

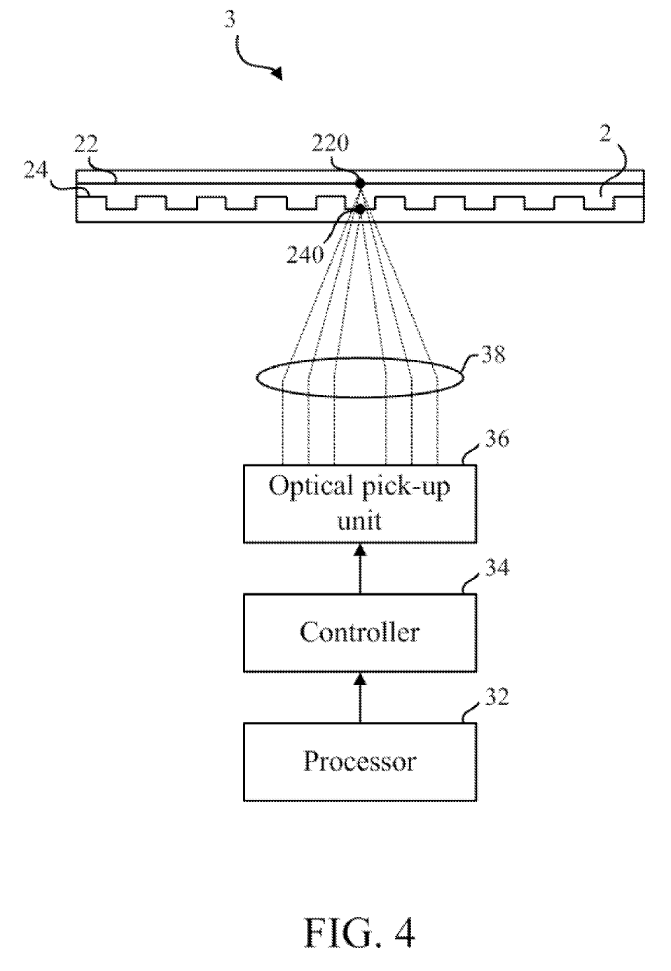

Referring to FIG. 4, FIG. 4 is a schematic diagram showing the configuration and function blocks of a recording system 3 according to a second preferred embodiment of the invention. As shown in FIG. 4, the recording system 3 includes a processor 32, a controller 34, an optical pick-up unit 36, and a multi-focal lens module 38.

The processor 32 is used for receiving data related to a first position 240 which is defined on the data layer 24. More specifically, the data received by the processor 32 is referred to a specific ATIP code marked on the data layer 24. The optical pick-up unit 36 is used for emitting a laser beam. The optical pick-up unit 36 is disposed in a way so as to face the bottom surface 28 of the optical disc 2 when the optical disc 2 is installed in the recording system 3. The multi-focal lens module 38 is capable of dividing the laser beam emitted by the optical pick-up unit 36 into a first beam portion and a second beam portion. The controller 34, which is operated by the processor 32, is used for controlling the optical pick-up unit 36 to focus the first beam portion on the data layer 24 to retrieve the predetermined address codes, such that the optical pick-up unit 36 is positioned at the first position 240; the optical pick-up unit 36 is also being controlled to focus the second beam portion at a second position 220 on the label layer 22 opposite to the first position 240, so as to record the image on the label layer 22.

Typically, the laser beam emitted by the optical pick-up unit 36 is focused on the data layer 24 to retrieve the ATIP codes, such that the recording system 3 can perform data reading/writing on the optical disc 2. The optical pick-up unit 36 is assumed to be operated at a first power when performing data reading/writing on the optical disc 2. By utilizing the multi-focal lens module 38, the laser beam emitted by the optical pick-up unit 36 is divided into the first beam portion and the second beam portion. Moreover, the first beam portion and the second beam portion are respectively focused on the data layer 24 and the label layer 22. In practical applications, the chemical coating deposited on the label layer 22 needs to absorb a certain amount of energy in order for it to change its color in response to the irradiation of the laser beam. Therefore, the multi-focal lens module 38 is designed to distribute most of the energy of the laser beam to the second beam portion. Besides, when performing label printing, the controller 34 controls the optical pick-up unit 36 to operate at a second power that is higher than the first power. Alternately, the controller 34 adjusts the irradiation time of the second beam portion on the second position 220 such that the thermal or light energy irradiated on the label layer 22 by the second beam portion is higher than the threshold. In other words, when performing label printing, the controller 34 can modulate the operating power of the optical pick-up unit 36 and/or the irradiation time of the second beam portion to irradiate a required amount of thermal or light energy on the second position 220 to form the image on the label layer 22. In one embodiment, the controller 34 modulates the irradiation time of the second beam portion by varying the velocity that the optical pick-up unit 36 moves against the label layer 22 of the optical disc 2.

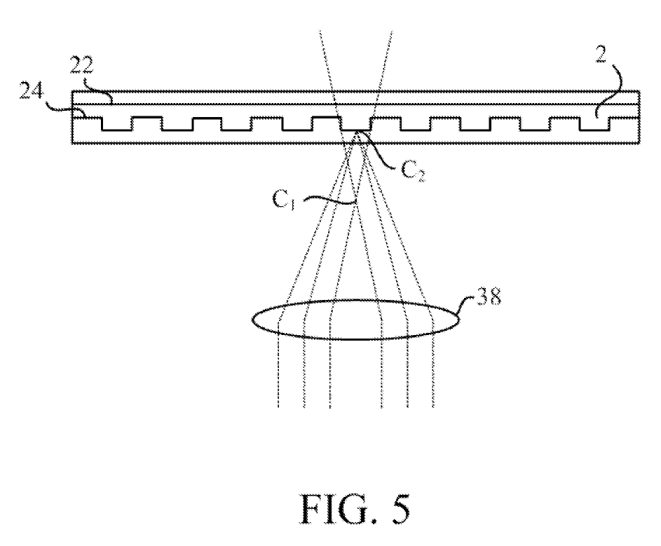

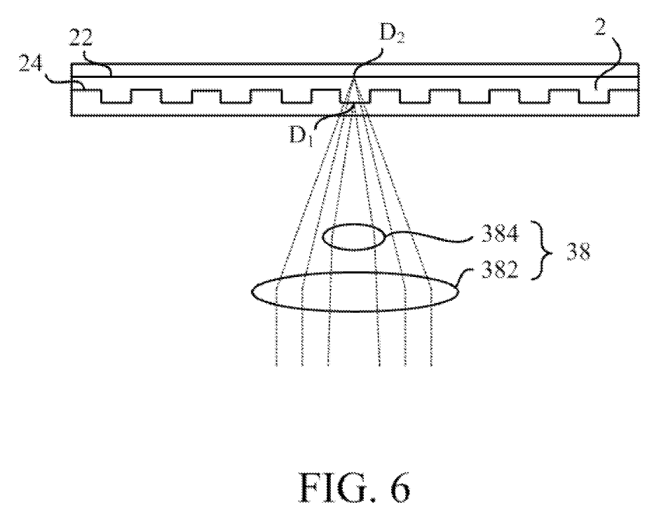

The focusing control of the recording system 3 according to the invention will now be explained in more detail hereinafter. When data reading/writing is being performed on the optical disc 2, the focal positions of the first beam portion and the second beam portion may be adjusted by moving the multi-focal lens module 38 perpendicularly to the optical disc 2. As shown in FIG. 5, the focal position of the first beam portion lies at C1 which is beyond the optical disc 2 due to adjusting the location of the multi-focal lens module 38. As a result, merely the second beam portion focused on C2 (i.e. on the data layer 24 of the optical disc 2) is applied to perform data reading/writing. Referring to FIG. 4, when performing label printing, the location of the multi-focal lens module 38 is adjusted, such that the first beam portion and the second beam portion are focused on the data layer 24 and the label layer 22, respectively. The first beam portion is utilized to retrieve the predetermined address codes, such that the optical pick-up unit 36 is positioned at the first position 240. The second beam portion is then utilized to record the image at a second position 220 on the label layer 22 opposite to the first position 240. In another embodiment, the multi-focal lens module 38 includes two separate lens element, as indicated by the first lens element 382 and the second lens element 384 shown in FIG. 6. The first lens element 382 is disposed on a path along which the laser beam travels to the optical disc 2, and the second lens element 384 is removably disposed the path. When data reading/writing is being performed on the optical disc 2, the second lens element 384 is removed from the path of the laser beam. The location of the first lens element 382 is adjusted, and the laser beam is entirely focused on the data layer 24 for the purpose of data reading/writing. As shown in FIG. 6, when performing label printing, the second lens element 384 is moved on the path of the laser beam, so as to divide the laser beam into the first beam portion and the second beam portion. The locations of the first lens element 382 and the second lens element 384 are adjusted, such that the first beam portion and the second beam portion are focused at D1 on the data layer 24 and D2 on the label layer 22, respectively.

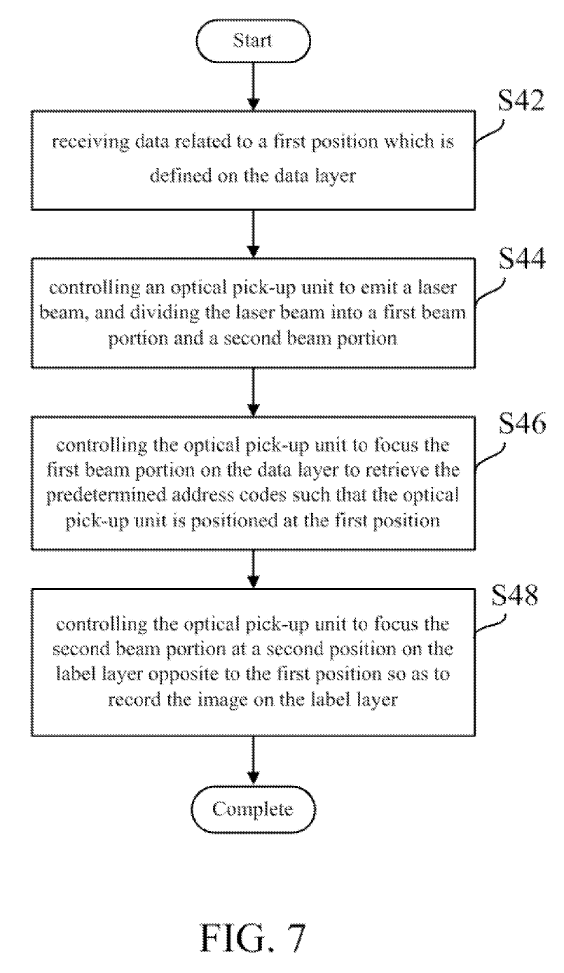

Referring to FIG. 7, FIG. 7 is a flowchart showing a method for recording an image onto a label layer of an optical disc according to a third preferred embodiment of the invention. The optical disc also includes a data layer, on which a plurality of predetermined address codes is marked. The recording method, according to the invention, first performs step S42 to receive data related to a first position, which is defined on the data layer. Next, step S44 is performed to control an optical pick-up unit to emit a laser beam and also to divide the laser beam into a first beam portion and a second beam portion. Afterwards, step S46 is performed to control the optical pick-up unit to focus the first beam portion on the data layer to retrieve the predetermined address codes, such that the optical pick-up unit is positioned at the first position. Finally, step S48 is performed to control the optical pick-up unit to focus the second beam portion at a second position on the label layer, opposite to the first position, so as to record the image on the label layer.

The descriptions regarding to the construction of the optical disc are the same as the first preferred embodiment and will be omitted here. The optical pick-up unit is disposed in a way, so as to face the bottom surface of the optical disc. The label layer is configured to form the image in response to thermal or light energy, which is irradiated by the second beam portion, higher than a threshold. In one embodiment, the power of the optical pick-up unit or the irradiation time of the second beam portion may be adjusted, such that the thermal or light energy irradiated on the label layer by the second beam portion is higher than the threshold.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for recording an image onto a label layer of an optical disc, the optical disc also comprising a data layer on which a plurality of predetermined address codes are marked, said system comprising:
a processor for receiving data related to a first position which is defined on the data layer;
an optical pick-up unit for emitting a laser beam;
a multi-focal lens module capable of dividing the laser beam emitted by the optical pick-up unit into a first beam portion and a second beam portion; and
a controller, operated by the processor, for controlling the optical pick-up unit to focus the first beam portion on the data layer to retrieve the predetermined address codes, such that the optical pick-up unit is positioned at the first position, and to focus the second beam portion at a second position on the label layer opposite to the first position.

2. The system of claim 1, wherein the plurality of predetermined address codes are Absolute Time In Pregroove (ATIP) codes.

3. The system of claim 1, wherein the label layer is configured to form the image in response to thermal or light energy, irradiated by the second beam portion, higher than a threshold.

4. The system of claim 3, wherein the controller adjusts the power of the optical pick-up unit or the irradiation time of the second beam portion, such that the thermal or light energy irradiated on the label layer by the second beam portion is higher than the threshold.

5. The system of claim 1, wherein the multi-focal lens module further comprises a first lens element and a second lens element, the first lens element is disposed on a path along which the laser beam travels to the optical disc, and the second lens element is removably disposed on the path, the laser beam is divided into the first beam portion and the second beam portion when the second lens element is moved on the path of the laser beam.

6. The system of claim 1, wherein the optical disc has a top surface and a bottom surface opposite to the top surface, the optical pick-up unit is disposed, so as to face the bottom surface of the optical disc when the optical disc is installed in said system.

7. The system of claim 6, wherein the label layer is formed on the top surface of the optical disc.

8. The system of claim 6, wherein the label layer is formed near the top surface of the optical disc.

9. A method for recording an image onto a label layer of an optical disc, the optical disc also comprising a data layer on which a plurality of predetermined address codes are marked, said method comprising the steps of:
controlling an optical pick-up unit to emit a laser beam, and dividing the laser beam into a first beam portion and a second beam portion;
focusing the first beam portion on the data layer to retrieve the predetermined address codes, such that the optical pick-up unit is positioned at a first position; and
focusing the second beam portion at a second position on the label layer opposite to the first position, so as to record the image on the label layer.

10. The method of claim 9, wherein the plurality of predetermined address codes are Absolute Time In Pregroove (ATIP) codes.

11. The method of claim 9, wherein the label layer is configured to form the image in response to thermal or light energy, irradiated by the second beam portion, higher than a threshold.

12. The method of claim 11, wherein the power of the optical pick-up unit or the irradiation time of the second beam portion is adjusted, such that the thermal or light energy irradiated on the label layer by the second beam portion is higher than the threshold.

13. The method of claim 9, wherein the optical disc has a top surface and a bottom surface opposite to the top surface, the optical pick-up unit is disposed, so as to face the bottom surface of the optical disc.

14. The method of claim 13, wherein the label layer is formed on the top surface of the optical disc.

15. The method of claim 13, wherein the label layer is formed near the top surface of the optical disc.
